(19) United States
(12) Patent Application Publication
(10) Pub. No.: US 2024/0187505 A1
(43) Pub. Date: Jun. 6, 2024

(54) ELECTRONIC APPARATUS SUPPORTING STREAMING AND CONTROLLING METHOD THEREOF

(71) Applicant: Samsung Electronics Co., Ltd., Suwon-si (KR)

(72) Inventors: Younjeong CHO, Suwon-si (KR); Eunjung LEE, Suwon-si (KR); Taesoo KIM, Suwon-si (KR); Taehyeong LEE, Suwon-si (KR); Jinyoung BAE, Suwon-si (KR); Jooyeong LEE, Suwon-si (KR)

(73) Assignee: Samsung Electronics Co., Ltd., Suwon-si (KR)

(21) Appl. No.: 18/381,748

(22) Filed: Oct. 19, 2023

Related U.S. Application Data
(63) Continuation of application No. PCT/KR2023/012790, filed on Aug. 29, 2023.

(30) Foreign Application Priority Data
Dec. 1, 2022 (KR) 10-2022-0165666

(51) Int. Cl. H04L 69/40; H04L 61/4511; H04L 65/60

(52) U.S. Cl. CPC H04L 69/40; H04L 61/4511; H04L 65/60

(57) ABSTRACT

An electronic apparatus including a memory configured to store at least one instruction, and at least one processor configured to execute the at least one instruction to obtain metadata corresponding to a content providing channel and a streaming Uniform Resource Identifier (URI) corresponding to streaming of content from a content providing server, transmit the metadata and the streaming URI to a client apparatus, and based on a streaming error of a first server being occurred while the client apparatus streams the content from the first server using the streaming URI, transmit, to an external server, a signal corresponding to a request for mapping a second server to the streaming URI so that the client apparatus streams from the second server.

### CROSS-REFERENCE TO RELATED APPLICATION(S)

This application is a continuation application, claiming priority under § 365(c), of an International application No. PCT/KR2023/012790, filed on Aug. 29, 2023, which claims priority under 35 U. S. C. § 119 to Korean Patent Application No. 10-2022-0165666, filed on Dec. 1, 2022, the disclosures of which are incorporated herein by reference in their entireties.

### BACKGROUND

### Field

This disclosure relates to an electronic apparatus and a controlling method thereof and more particularly, to an electronic apparatus that supports streaming and a controlling method thereof.

### Description of the Related Art

As for a method of transmitting media data via a network, there are a download method and a streaming method. The streaming method is a method in which a streaming server transmits media data in real time and a client reproduces the received media data in real time.

Unlike the download method in which reproduction of media data starts after all of the media data has been transmitted and received, the streaming method allows a client to transmit and receive media data in real time through a logical channel established between the streaming server and the client.

### SUMMARY

An electronic apparatus according to one or more embodiments includes a memory configured to store at least one instruction, and at least one processor configured to execute the at least one instruction to obtain metadata corresponding to a content providing channel and a streaming Uniform Resource Identifier (URI) corresponding to streaming of content from a content providing server, transmit the metadata and the streaming URI to a client apparatus, and based on a streaming error of a first server being occurred while the client apparatus streams the content from the first server using the streaming URI, transmit, to an external server, a signal corresponding to a request for mapping a second server to the streaming URI so that the client apparatus streams from the second server.

According to one or more embodiments, the signal transmitted to the external server is a signal corresponding to a request for matching and storing a URI of the second server to the streaming URI in a database of the external server.

According to one or more embodiments, the at least one processor is configured to execute the at least one instruction to, based on a streaming error of the second server being occurred, transmit, to a Domain Name System (DNS) server, a signal corresponding to a request for mapping a third server to the streaming URI so that the client apparatus streams from the third server.

According to one or more embodiments, the second server is a server that provides content that is same as the content streamed from the first server.

According to one or more embodiments, the second server is a server providing streaming error occurrence information of the first server.

According to one or more embodiments, the at least one processor is configured to execute the at least one instruction to obtain a plurality of URIs for connecting to a plurality of servers that stream the content: and set one of the plurality of obtained URIs as a streaming URI.

According to one or more embodiments, the memory is configured to store a plurality of first streaming URIs for streaming the content, and the at least one processor is configured to execute the at least one instruction to obtain a plurality of second streaming URIs for streaming the content from the content providing server, and set one of the plurality of first streaming URIs and the plurality of second streaming URIs as a streaming URI.

According to one or more embodiments, the at least one processor is configured to execute the at least one instruction to receive a first URI for connecting to the first server and a second URI for connecting to the second server, transmit a streaming URI based on the first URI and a back-up URI based on the second URI to the client apparatus, and based on a streaming error of the first server being occurred, control the client apparatus to stream from the second server using the back-up URI. A controlling method of an electronic apparatus according to one or more embodiments includes obtaining metadata corresponding to a content providing channel and a streaming Uniform Resource Identifier (URI) corresponding to streaming of content from a content providing server, transmitting the metadata and the streaming URI to a client apparatus, and based on a streaming error of a first server being occurred while the client apparatus streams the content from the first server using the streaming URI, transmitting, to an external server, a signal corresponding to a request for mapping a second server to the streaming URI so that the client apparatus streams from the second server.

According to one or more embodiments, the signal transmitted to the external server is a signal corresponding to a request for matching and storing a URI of the second server to the streaming URI in a database of the external server.

According to one or more embodiments the controlling method includes, based on a streaming error of the second server being occurred, transmitting, to a Domain Name System (DNS) server, a signal corresponding to a request for mapping a third server to the streaming URI so that the client apparatus streams from the third server.

According to one or more embodiments, the second server is a server providing content that is same as the content streamed from the first server.

According to one or more embodiments, the second server is a server providing streaming error occurrence information of the first server.

According to one or more embodiments, the obtaining includes obtaining a plurality of URIs for connecting to a plurality of servers that stream the content; and setting one of the plurality of obtained URIs as a streaming URI.

According to one or more embodiments, a non-transitory computer-readable recording medium stores a program that, when executed by a processor, causes a control method to be performed for controlling an electronic apparatus, the controlling method including obtaining metadata corresponding to a content providing channel and a streaming Uniform Resource Identifier (URI) corresponding to streaming of content from a content providing server, transmitting the metadata and the streaming URI to a client apparatus, and based on a streaming error of a first server being occurred while the client apparatus streams the content from the first server using the streaming URI, transmitting, to an external server, a signal corresponding to a request for mapping a second server to the streaming URI so that the client apparatus streams from the second server.

### BRIEF DESCRIPTION OF THE DRAWINGS

FIG. 1 is a block diagram provided to explain configuration of an electronic apparatus according to one or more embodiments:

FIG. 2 is a block diagram provided to explain configuration of a client apparatus according to one or more embodiments:

FIG. 3 is a view provided to explain an operation of an electronic apparatus and a client apparatus according to one or more embodiments:

FIG. 4 is a view provided to explain an operation of an electronic apparatus and a client apparatus according to one or more embodiments:

FIG. 5 is a flowchart provided to explain an operation of an electronic apparatus according to one or more embodiments: and

FIG. 6 is a flowchart provided to explain an operation of a client apparatus according to one or more embodiments.

### DETAILED DESCRIPTION

The disclosure may be variously modified and have various embodiments. Therefore, specific embodiments are shown in the accompanying drawings and described in detail in the specification. However, it is to be understood that the scope of the disclosure is not limited to the specific embodiments, and includes various modifications, equivalents, or alternatives according to the embodiments of the disclosure. Throughout the accompanying drawings, similar components are denoted by similar reference numerals.

In describing the disclosure, the description omits a detailed description of a case where the detailed description for the known functions or configurations related to the disclosure is determined to unnecessarily obscure the gist of the disclosure.

In addition, the following embodiments may be modified in various different forms, and the scope and spirit of the disclosure are not limited to the following embodiments. Rather, these embodiments are provided to make the disclosure thorough and complete, and to completely transfer the spirit of the disclosure to those skilled in the art.

Terms used in the disclosure are used only to describe the specific embodiments rather than limiting the scope of the disclosure. A term of a singular number may include its plural number unless explicitly indicated otherwise in the context.

In the disclosure, an expression “have,” “may have,” “include,” “may include” or the like, indicates existence of a corresponding feature (for example, a numerical value, a function, an operation or a component such as a part), and does not exclude existence of an additional feature.

In the disclosure, expressions “A or B,” “least one of A and/or B,” “one or more of A and/or B” and the like, may include all possible combinations of items enumerated together. For example, “A or B,” “at least one of A and B” or “at least one of A or B” may indicate all of 1) a case where at least one A is included, 2) a case where at least one B is included, or 3) a case where both of at least one A and at least one B are included.

Expressions “first,” “second” and the like, used in the disclosure may indicate various components regardless of a sequence or importance of the components. These expressions are used only to distinguish one component from another component, and do not limit the corresponding components.

In case that any component (for example, a first component) is mentioned to be “(operatively or communicatively) coupled with/to” or “connected to” another component (for example, a second component), it is to be understood that any component is directly coupled to another component or may be coupled to another component through still another component (for example, a third component).

On the other hand, in case that any component (for example, a first component) is mentioned as being “directly coupled” or “directly connected” to another component (for example, a second component), it is to be understood that still another component (for example, a third component) does not exist between any component and another component.

An expression “configured (or set) to” used in the disclosure may be replaced by an expression “suitable for,” “having the capacity to,” “designed to,” “adapted to,” “made to” or “capable of” based on a situation. The expression “configured (or set) to” may not necessarily indicate “specifically designed to” in hardware.

Instead, an expression a “device configured to” in any situation may indicate that the device may “perform˜” together with another device or component. For example, “a processor configured (or set) to perform A, B and C” may indicate a dedicated processor (for example, an embedded processor) for performing the corresponding operations or a generic-purpose processor (for example, a central processing unit (CPU) or an application processor) that may perform the corresponding operations by executing one or more software programs stored in a memory device.

In the embodiments, a “module” or a “˜er/or” may perform at least one function or operation, and be implemented by hardware or software, or be implemented by a combination of hardware and software. In addition, a plurality of “modules” or a plurality of “˜ers/ors” may be integrated in at least one module and implemented by at least one processor except for a “module” or an “˜er/or” that needs to be implemented by specific hardware.

Meanwhile, various elements and regions in the drawings are schematically shown. Therefore, the spirit of the disclosure is not limited by relative sizes or intervals shown in the accompanying drawings.

Hereinafter, the embodiments of the disclosure are described in detail with reference to the accompanying drawings for those skilled in the art to which the disclosure pertains to easily practice the disclosure.

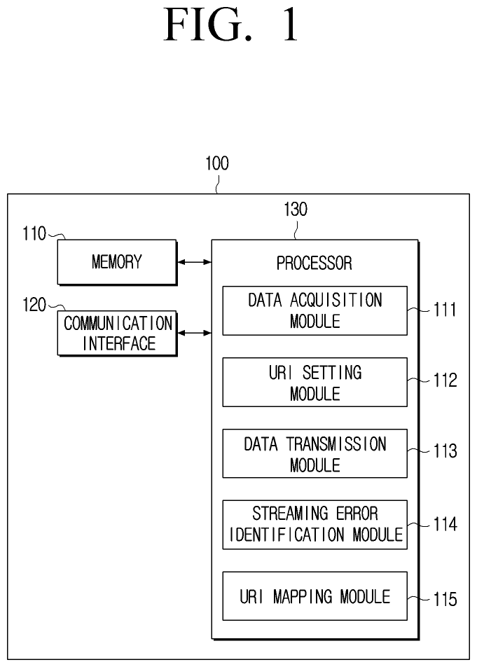

FIG. 1 is a block diagram provided to explain configuration of an electronic apparatus according to one or more embodiments.

An electronic apparatus 100 may include a memory 110, a communication interface 120 and a processor 130. Some of the above-described components may be omitted from the electronic apparatus 100, and other components may further be included in the electronic apparatus 100.

In addition, the electronic apparatus 100 may be implemented as a server, but this is merely an example, and the electronic apparatus 100 may be implemented in various forms such as a set-top box, a TV, a smart TV, a smartphone, a mobile phone, a personal digital assistant (PDA), a laptop, a media player, an e-book reader, a digital broadcasting terminal, a navigation device, a kiosk, a MP3 player, a wearable device, a home appliance, and other mobile or non-mobile computing devices. In addition, the electronic apparatus 100 may be connected to other external devices to perform one or more functions. Further, the electronic apparatus 100 may be a server that provides a streaming service.

The memory 110 may store at least one instruction regarding the electronic apparatus 100. The memory 110 may store an Operating System (O/S) for driving the electronic apparatus 100. In addition, the memory 110 may store various software programs or applications for operating the electronic apparatus 100 according to various embodiments of the present disclosure. Further, the memory 110 may include a semiconductor memory such as a flash memory or a magnetic storage medium such as a hard disk.

Specifically, the memory 110 may store various software modules for the electronic apparatus 100 to operate according to various embodiments of the disclosure, and the processor 130 may execute the various software modules stored in the memory 110 to control an operation of the electronic apparatus 100. That is, the memory 110 may be accessed by the processor 130, and data can be read/written/modified/deleted/updated by the processor 130.

Meanwhile, the term “memory 110” herein may be meant to include the memory 110, a ROM (not shown) or a RAM (not shown) in the processor 130, or a memory card (not shown) (e.g., a micro SD card or a memory stick) mounted in the electronic apparatus 100.

In addition, the communication interface 120 may include circuitry and communicate with an external apparatus and a server. The communication interface 120 may perform the communication with the external apparatus or the server based on a wired or wireless communication method. The communication interface 120 may include a Bluetooth module (not shown), a wireless-fidelity (Wi-Fi) module (not shown), an infrared (IR) module, a local area network (LAN) module, an Ethernet module, or the like. Here, each communication module may be implemented in the form of at least one hardware chip. In addition to the above-described communication methods, a wireless communication module may include at least one communication chip performing the communication based on various wireless communication standards such as zigbee, universal serial bus (USB), mobile industry processor interface camera serial interface (MIPI CSI), third generation (3G), 3rd generation partnership project (3GPP), long term evolution (LTE), LTE advanced (LTE-A), 4th generation (4G), and 5th generation (5G). However, this configuration is only an example, and the communication interface 120 may use at least one communication module among various communication modules. In addition, the electronic apparatus 100 may control the external apparatus to display a user interface (UI) through the communication interface 120.

The processor 130 may control the overall operations and functions of the electronic apparatus 100. Specifically, the processor 130 is connected to the configuration of the electronic apparatus 100 including the memory 110, and may control the overall operations of the electronic apparatus 100 by executing at least one instruction stored in the memory 110 as described above.

The processor 130 may be implemented in various ways. As an example, the processor 130 may be implemented as at least one application specific integrated circuit (ASIC). As an additional example, the processor 130 may be implemented as at least one embedded processor. As an additional example, the processor 130 may be implemented as at least one microprocessor. As an additional example, the processor 130 may be implemented as at least one hardware control logic. As an additional example, the processor 130 may be implemented as at least one hardware finite state machine (FSM). As an additional example, the processor 130 may be implemented as at least one digital signal processor (DSP). Moreover, the processor 130 may be implemented as any combination of ASIC(s), embedded processor(s), microprocessor(s), hardware control logic(s), hardware FSM(s), DSP(s). For example, the processor 130 may be implemented as any combination of at least one ASIC, at least one embedded processor, at least one microprocessor, at least one hardware control logic, at least one hardware FSM, at least one DSP. Meanwhile, in the present disclosure, the term “the processor 130” may be meant to include a Central Processing Unit (CPU), a Graphic Processing Unit (GPU), a Main Processing Unit (MPU), and the like.

The operation of the processor for implementing various embodiments of the present disclosure may be implemented through a plurality of modules.

Specifically, data regarding a plurality of modules according to the present disclosure may be stored in the memory 110, and the processor 130 may access the memory 110 to load the data regarding the plurality of modules onto a memory or a buffer within the processor 130 and then, implement various embodiments according to the present disclosure using the plurality of modules. In this case, the plurality of modules may include a data acquisition module 111, a URI setting module 112, a data transmission module 113, a streaming error identification module 114, and a URI mapping module 115.

However, at least one of the plurality of modules according to the present disclosure may be implemented as hardware and included in the processor 130 in the form of a system on chip.

Alternatively, at least one of the plurality of modules according to the present disclosure may be implemented as a separate external device, and the electronic apparatus 100 and each module may perform communication and perform operations according to the present disclosure.

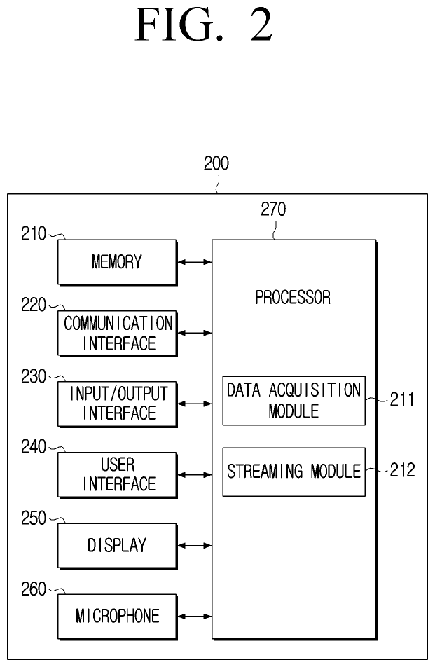

FIG. 2 is a block diagram provided to explain configuration of a client apparatus according to one or more embodiments.

A client apparatus 200 may include a memory 210, a communication interface 220, an input/output interface 230, a user interface 240, a display 250, a microphone 260, and a processor 270. Some of the above-described components may be omitted from the client apparatus 200, and other components may further be included in the client apparatus 200.

The client apparatus 200 may be implemented as a TV, but this is only an embodiment, and the client apparatus 200 may be implemented in various forms such as a set-top box, a smart TV, a smartphone, a mobile phone, a personal digital assistant (PDA), a laptop, a media player, an e-book reader, a digital broadcasting terminal, a navigation, a kiosk, an MP3 player, a wearable device, a home appliance, other mobile or non-mobile computing devices, and the like. In addition, the client apparatus 200 may be connected to other external devices and perform one or more functions. In addition, the client apparatus 100 may be an apparatus that receives a streaming service.

The memory 210 may store at least one instruction regarding the client apparatus 200. The memory 210 may store an Operating System (O/S) for driving the client apparatus 200. In addition, the memory 210 may store various software programs or applications for operating the client apparatus 200 according to various embodiments of the present disclosure. Further, the memory 210 may include a semiconductor memory such as a flash memory or a magnetic storage medium such as a hard disk.

Specifically, the memory 210 may store various software modules for the client apparatus 200 to operate according to various embodiments of the disclosure, and the processor 270 may execute the various software modules stored in the memory 210 to control an operation of the client apparatus 200. That is, the memory 210 may be accessed by the processor 270, and data can be read/written/modified/deleted/updated by the processor 270.

Meanwhile, the term “memory 210” herein may be meant to include the memory 210, a ROM (not shown) or a RAM (not shown) in the processor 270, or a memory card (not shown) (e.g., a micro SD card or a memory stick) mounted in the client apparatus 200.

In addition, the communication interface 220 may include circuitry and communicate with an external apparatus and a server. The communication interface 220 may perform the communication with the external apparatus or the server based on a wired or wireless communication method. The communication interface 220 may include a Bluetooth module (not shown), a wireless-fidelity (Wi-Fi) module (not shown), an infrared (IR) module, a local area network (LAN) module, an Ethernet module, or the like. Here, each communication module may be implemented in the form of at least one hardware chip. In addition to the above-described communication methods, a wireless communication module may include at least one communication chip performing the communication based on various wireless communication standards such as zigbee, universal serial bus (USB), mobile industry processor interface camera serial interface (MIPI CSI), third generation (3G), 3rd generation partnership project (3GPP), long term evolution (LTE), LTE advanced (LTE-A), 4th generation (4G), and 5th generation (5G). However, this configuration is only an example, and the communication interface 220 may use at least one communication module among various communication modules. In addition, the client apparatus 200 may control the external apparatus to display a user interface (UI) through the communication interface 220.

The input/output interface 230 may be one of a High Definition Multimedia Interface (HDMI), a Mobile High-Definition Link (MHL), a Universal Serial Bus (USB), a Display Port (DP), a Thunderbolt, a Video Graphics Array (VGA) port, an RGB port, a D-subminiature (D-SUB), and a Digital Visual Interface (DVI).

The input/output interface 230 may input/output at least one of audio and video signals. According to one or more embodiments, the input/output interface 230 may include a port for inputting and outputting only the audio signal and a port for inputting and outputting only the video signal as separate ports, or may be implemented as one port for inputting and outputting both the audio signal and the video signal. The client apparatus 200 may output a video signal for displaying a UI including a UI element corresponding to content through the input/output interface 230.

The user interface 240 is configured to receive a user instruction for controlling the client apparatus 200. The user interface 240 may be implemented as buttons, a touch pad, a mouse, a keyboard, etc., or may be implemented as a touch screen capable of performing both a display function and a manipulation input function. Here, the buttons may be various types of buttons such as mechanical buttons, a touch pad, a wheel, etc. formed on an arbitrary region such as the front, side, or rear portion of the appearance of the main body of the client apparatus 200. The client apparatus 200 may obtain various user inputs through the user interface 240. The client apparatus 200 may obtain a user input for selecting a UI element included in a UI displayed on the display 250 through the user interface 240.

The display 250 may be implemented as a display including a self-light emitting element or a display including a non-light emitting element and a backlight. For example, the display may be implemented in various types of displays such as a liquid crystal display (LCD), an organic light emitting diodes (OLED) display, a light emitting diodes (LED), a micro light emitting diode (micro LED), a mini LED, a plasma display panel (PDP), a quantum dot (QD) display, a quantum dot light-emitting diode (QLED). The display 250 may also include a driving circuit, a backlight unit, and the like, which may be implemented in a form such as an a-si thin film transistor (TFT), a low temperature poly silicon (LTPS) TFT, an organic TFT (OTFT), or the like.

According to one or more embodiments, the client apparatus 200 may provide various screens such as a UI including a UI element. In this case, the client apparatus 200 may control the display 250 to display various screens. In addition, the client apparatus 200 may be connected to an external display apparatus (e.g., a TV, a monitor, a tablet, a laptop computer, a desktop computer, etc.) with wire or wirelessly through the communication interface 220 or the input/output interface 230, and the client apparatus 200 may transmit a signal related to controlling the external display apparatus to the external display apparatus so that the screen is displayed on the external display apparatus and provided to the user.

In addition, the client apparatus 200 may transmit the signal to the external display apparatus so that audio is output along with the screen. In other words, the client apparatus 200 may transmit a video signal for displaying the screen and an audio signal for outputting audio to the external display apparatus. In this case, the client apparatus 200 may transmit the video signal and the audio signal to the external display apparatus through the same communication interface 220 or the same input/output interface 230, but this is only an example. The client apparatus 200 may transmit the video signal and the audio signal to the external display apparatus using different means.

For example, the client apparatus 200 may transmit both the video signal and the audio signal to the external display apparatus through the input/output interface 230 such as HDMI, DP or Thunderbolt, but this is only an example. The client apparatus 200 may transmit the video signal and the audio signal to the external display apparatus using different interfaces.

The microphone 260 may refer to a module that obtains sound and converts it into an electrical signal, and may include a condenser microphone, a ribbon microphone, a moving coil microphone, a piezoelectric element microphone, a carbon microphone, and a Micro Electro Mechanical System (MEMS) microphone. In addition, the microphone 260 may be implemented in non-directional, bi-directional, unidirectional, sub-cardioid, super-cardioid, and hyper-cardioid methods.

In addition, the client apparatus 200 may obtain a user voice through the microphone 260. Alternatively, the client apparatus 200 may obtain a user voice from an external device having a microphone. Specifically, a microphone may be provided in a separate external device such as a remote controller, a smartphone, a speaker, etc. that transmits a signal to the client apparatus 200. Here, the microphone provided in the external device may digitize the analog voice signal, and the client apparatus 200 may perform a communication connection with the external device through the communication interface 220 and receive the digitized voice signal.

In this case, a remote control application may be installed in the external device. The external device may control the client apparatus 200 through the remote control application, and perform a user voice recognition function. In this case, the external device may perform communication with the client apparatus 200 and a server through a plurality of communication interfaces.

The external device in which the remote control application is installed may be a smartphone, but this is only an example. The external device in which the remote control application is installed may be implemented through various devices in which an application such as an AI speaker, etc. can be installed.

The client apparatus 200 may be connected to the external device with wire or wirelessly through the communication interface 220 or the input/output interface 230, and the client apparatus 200 may receive an audio signal regarding a user voice from the external device.

The client apparatus 200 may perform a communication connection with the external device through the communication interface 220 and transmit an audio signal to the external device.

Here, the external device may be a Speech-to-Text (STT) server that convers an audio signal into a text. The client apparatus 200 may perform a communication connection with a STT server through the communication interface 220 to receive data processed by the STT server, and transmit the received data to another server. However, the present disclosure is not limited thereto, and the client apparatus 200 may obtain the processed data through a STT module included in the client apparatus 200 without transmitting an audio signal to the external device.

In addition, the client apparatus 200 may control the configuration of the client apparatus 200 to perform various operations using text data obtained from the STT server or the STT module. However, the present disclosure is not limited thereto, and the client apparatus 200 may perform a communication connection with the STT server or the external server through the communication interface 220 to transmit the obtained text data to the STT server or the external server, and control the configuration of the client apparatus 200 to perform various operations based on the data received from the STT server or the external device.

The processor 270 control the overall operations and functions of the client apparatus 200. Specifically, the processor 270 is connected to the configuration of the client apparatus 200 including the memory 210, and may control the overall operations of the client apparatus 200 by executing at least one instruction stored in the memory 210 as described above.

The processor 270 may be implemented in various ways. For example, the processor 270 may be implemented as at least one application specific integrated circuit (ASIC). As an additional example, the processor 270 may be implemented as at least one embedded processor. As an additional example, the processor 270 may be implemented as at least one a microprocessor. As an additional example, the processor 270 may be implemented as at least one hardware control logic. As an additional example, the processor 270 may be implemented as at least one a hardware finite state machine (FSM). As an additional example, the processor 270 may be implemented as at least one a digital signal processor (DSP). Moreover, the processor 270 may be implemented as any combination of ASIC(s), embedded processor(s), microprocessor(s), hardware control logic(s), hardware FSM(s), DSP(s). For example, the processor 270 may be implemented as any combination of at least one ASIC, at least one embedded processor, at least one microprocessor, at least one hardware control logic, at least one hardware FSM, at least one DSP. Meanwhile, in the present disclosure, the term ‘processor 270’ may be used to include a Central Processing Unit (CPU), a Graphic Processing Unit (GPU), a Main Processing Unit (MPU), etc.

The operation of the processor 270 to implement various embodiments of the present disclosure may be implemented through a plurality of modules.

Specifically, data regarding a plurality of modules according to the present disclosure may be stored in the memory 210, and the processor 270 may access the memory 210, load the data regarding the plurality of modules onto a memory or a buffer inside the processor 270, and implement various embodiments according to the present disclosure using the plurality of modules. In this case, the plurality of modules may include a data acquisition module 211 and a streaming module 212.

However, at least one of the plurality of modules according to the present disclosure may be implemented as hardware and included in the processor 270 in the form of a system on chip.

Alternatively, at least one of the plurality of modules according to the present disclosure may be implemented as at least one separate external device, and the client apparatus 200 and each module may perform communication to perform operations according to the present disclosure.

Hereinafter, the operations of a plurality of modules of the electronic apparatus 100 and the operations of a plurality of modules of the client apparatus 200 according to the present disclosure will be described in detail.

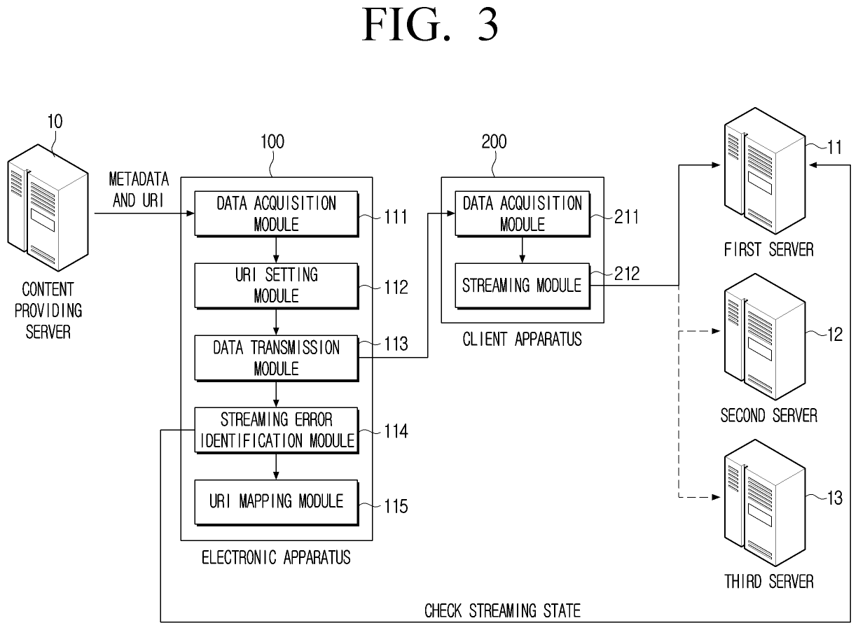

FIG. 3 is a view provided to explain an operation of an electronic apparatus and a client apparatus according to one or more embodiments.

Referring to FIG. 3, the data acquisition module 111 may obtain a Uniform Resource Identifier (URI) for streaming metadata corresponding to a channel that provides content from a content providing server 10 and content provided by the channel.

Here, the metadata corresponding to a channel that provides content may include schedule information for broadcasting content provided by the channel.

Also, the URI for streaming content provided by the channel may refer to a URI for accessing a streaming server providing content broadcasted by the channel. In this case, the URI for the channel may be one or multiple. For example, a URI corresponding to streaming of content provided by the channel may include a first URI and a second URI. Also, the URI may be an address indicating a resource on the Internet. For example, the URI may be provided in the form of ‘https://abc.com’.

When the metadata corresponding to the channel that provides content and the URI corresponding to streaming of content are obtained, the URI setting module 112 may set a streaming URI corresponding to streaming of content provided by the channel. Here, the streaming URI may refer to a URI used to streaming content provided by the channel.

Also, the URI setting module 112 may set a streaming URI corresponding to content provided by the channel based on at least one of URI information obtained from the content providing server 10 and URI information pre-stored in the memory 110. Specifically, the URI setting module 112 may set one of the URI pre-stored in the memory 110 and the URI obtained from the content providing server 10 as a streaming URI.

In this case, the URI setting module 112 may set a priority for each of the URI obtained from the content providing server 10 and the URI pre-stored in the memory 110. Also, the URI setting module 112 may set a URI having the highest priority as a streaming URI.

For example, the data acquisition module 111 may obtain a first URI corresponding to a content providing channel and a second URI corresponding to a content providing channel from the content providing server 10. Also, the memory 110 may store a third URI corresponding to a content providing channel and a fourth URI corresponding to a content providing channel. In this case, the URI setting module 112 may set one of the first URI, the second URI, the third URI, and the fourth URI as a streaming URI.

In this case, the URI setting module 112 may set a priority for each of the first URI, the second URI, the third URI, and the fourth URI. Here, the URI setting module 112 may set a URI having the highest priority from among the first URI, the second URI, the third URI, and the fourth URI as a streaming URI.

Meanwhile, the URI obtained from the content providing server 10 may be a streaming URI, and the URI setting module 112 may omit the operation of setting a streaming URI.

Meanwhile, according to one or more embodiments, the electronic apparatus 100 may not perform communication with the content providing server 10, and may set a streaming URI based on metadata corresponding to a channel that provides content pre-stored in the memory 110 and a URI for streaming content.

Specifically, the memory 110 may store metadata corresponding to a channel that provides content and information regarding at least one URI corresponding to streaming of the content. Also, the electronic apparatus 100 may set a streaming URI corresponding to streaming of the content based on the metadata stored in the memory 110 and the information regarding at least one URI.

When a streaming URI is set, the data transmission module 113 may transmit metadata corresponding to a channel that provides content and a streaming URI corresponding to streaming of the content to the client apparatus 200.

In other words, the data acquisition module 211 of the client apparatus 200 may obtain metadata corresponding to a channel that provides content and a streaming URI corresponding to streaming of the content from the electronic apparatus 100.

In this case, when a user input for watching a channel that provides content is obtained, the streaming module 212 may receive streaming data from a first server 11 using a streaming URI corresponding to streaming of the content.

Specifically, the streaming module 212 may transmit the streaming URI to an external server. In this case, the streaming URI may be mapped to the URI of the first server in the database of the external server. Here, the external server may mean a Domain Name System (DNS) server.

Accordingly, the streaming module 211 may receive streaming data from the first server 11 that is mapped to the streaming URI in the database of the external server.

Meanwhile, the streaming error identification module 114 of the electronic apparatus 100 may identify whether a streaming error occurs in the first server 11 mapped to the streaming URI.

Specifically, the streaming error identification module 114 may request streaming data from the first server 11 using the first URI and receive the streaming data. In this case, a streaming error may occur for various reasons such as an error of the first server 11, an error of the streaming data, a communication error, etc. In this case, the streaming error identification module 114 may identify that a streaming error of the first server 11 occurs.

In this case, the streaming error identification module 114 may identify whether a streaming error occurs only for the streaming server in which the client apparatus 200 is streaming. In other words, the streaming error identification module 114 may not need to identify a streaming error for each of a plurality of streaming servers. Accordingly, the electronic apparatus 100 of the present disclosure may identify a streaming error by efficiently using limited computing resources without identifying a streaming error for each of a plurality of streaming servers and solve a streaming error by controlling the external server to change the streaming server mapped to the streaming URI.

Specifically, the memory 110 may store a URI for each of a plurality of streaming servers corresponding to a channel that provides content. For example, the memory 110 may store a URI of the first server 11, a URI of the second server 12 and a URI of the third server 13. In this case, the first server, the second server 12 and the third server may be a server that streams content provided by a channel.

In this case, the URI mapping module 115 may transmit a signal corresponding to a request for mapping the second server 12 to the streaming URI to the external server so that the client apparatus 200 streams from the second server 12.

In other words, when a streaming error of the first server 11 occurs while the client apparatus 200 streams content from the first server 11 using the streaming URI, the URI mapping module 115 may transmit a signal corresponding to a request for mapping the second server 12 to the streaming URI to the external server. Specifically, when an error of the first server 11 is identified, the URI mapping module 115 may transmit a signal corresponding to a request for matching and storing the URI of the second server 12 with the streaming URI in the database of the external server, to the external server.

In other words, the URI mapping module 115 may transmit a signal corresponding to a request for matching and storing the URI of the second server 12 with the streaming URI in the database of the external server, to the external server.

When a signal corresponding to a request for mapping the URI of the second server 12 with the streaming URI is received, the external server may match the URI of the second server 12 with the streaming URI and store the same in the database.

Accordingly, the client apparatus 200 may receive streaming data from the second server 12 through the external server using the streaming URI. According to the above-described method, when a streaming error occurs, the client apparatus 200 may continuously perform streaming without an operation of obtaining a further URI.

According to the prior art, there is a problem in that the content providing server 10 must identify whether a streaming error occurs and recover the streaming error. Also, according to the prior art, there is a problem in that a streaming error issue is not solved until the electronic apparatus 100 obtains a URI regarding a streaming server in which a streaming error does not occur and transmits the obtained URI to the client apparatus 200. Accordingly, the electronic apparatus 100 of the present disclosure may identify whether a streaming error occurs in real time with respect to a server that the client apparatus 200 is streaming, and when a streaming error occurs, immediately recover the streaming error by remapping the streaming server mapped to the streaming URI without additionally obtaining or transmitting a URI.

Meanwhile, the second server 12 may be a streaming server that provides content provided by the first channel. Accordingly, even if a streaming error occurs in the first server 11, the client apparatus 200 may receive streaming data from the second server 12 using pre-stored URI information.

Alternatively, the second server 12 may be a server that streams streaming error generation information of a streaming server that provides content provide by the first channel. Accordingly, when a streaming error occurs, the client apparatus 200 may provide the user with information that the cause of the streaming error is not the client apparatus 200 but the streaming server.

Meanwhile, according to one or more embodiments, when a streaming error of the streaming server is identified, the client apparatus 200 may perform streaming by replacing or updating the streaming URI.

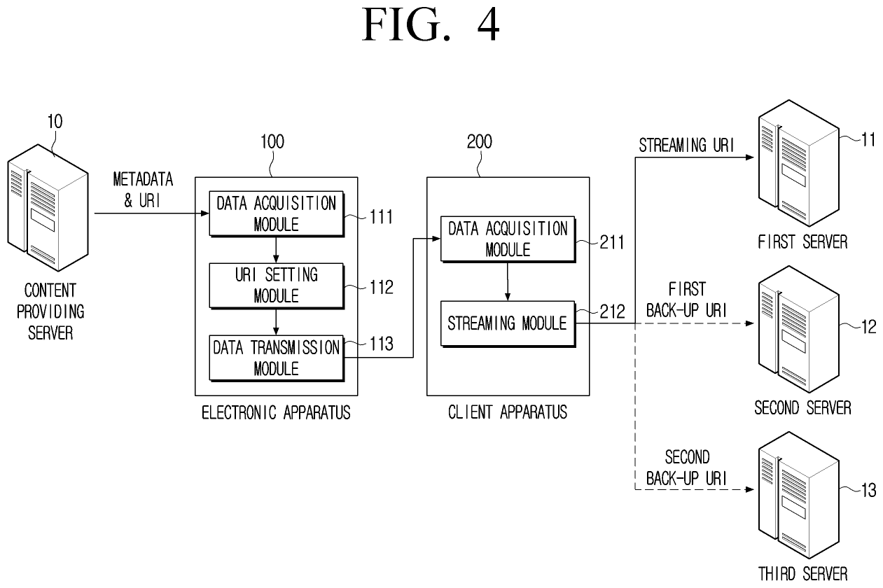

Referring to FIG. 4, the data acquisition module 111 may obtain metadata corresponding to a channel that provides content from the content providing server 10 and a URI for streaming content provided by the channel. In this case, the URI for streaming content may include at least one of the first URI for accessing the first server 11 that provides content, the second URI for accessing the second server 12 that provides content and the third URI for accessing the third server 13 that provides content.

When metadata corresponding to a channel that provides content and an URI corresponding to streaming of content provided by the channel are obtained, the URI setting module 112 may set a streaming URI (e.g., the first URI) and a back-up URI (e.g., the second URI) for streaming content provided by the channel. Here, the back-up URI may refer to a URI for accessing the second server 12 when a streaming error occurs while receiving streaming data from the first server 11 using the streaming URI. In this case, the second server 12 may be a server that streams content provided by the channel.

In this case, the URI setting module 112 may set a streaming URI and a back-up URI for streaming content provided by the channel based on at least one of the URI information obtained from the content providing server 10 and the URI information pre-stored in the memory 111. Specifically, the URI setting module 112 may set one of the URI pre-stored in the memory 111 and the URI obtained from the content providing server 10 as a streaming URI and a back-up URI.

For example, the data acquisition module 111 may obtain a first URI regarding a content providing channel and a second URI regarding a content providing channel from the content providing server 10. The memory 110 may store a third URI and a fourth URI regarding a content providing channel. In this case, the URI setting module 112 may set one of the first URI, the second URI, the third URI, and the fourth URI as a streaming URI and one of the remaining URIs as a back-up URI. In this case, the set back-up URI may be one or more.

When a streaming URI and a back-up URI are set, the data transmission module 113 may transmit metadata corresponding to a channel that provides content and the streaming URI and the back-up URI corresponding to streaming of content provided by the channel, to the client apparatus 200.

In other words, the data acquisition module 211 of the client apparatus 200 may obtain metadata corresponding to a content providing channel from the electronic apparatus 100 and a streaming URI and a back-up URI corresponding to streaming of content provided by the channel.

In this case, when a user input for selecting a channel that provides content is obtained, the streaming module 212 may receive streaming data from the first server 11 using a streaming URI corresponding to the content providing channel.

When a streaming error of the first server 11 occurs while streaming content from the first server 11 using the streaming URI, the streaming module 212 may stream content from the second server 12 using a back-up URI.

In other words, by transmitting a streaming URI based on the first URI and a back-up URI based on the second URI to the client apparatus 200, when a streaming error of the first server 11 occurs, the electronic apparatus 100 may control the client apparatus 200 to stream from the second server 12 using the back-up URI.

Specifically, the streaming module 212 may identify a streaming error of the first server 11.

When a streaming error of the first server 11 is identified, the streaming module 212 may receive streaming data from the second server 12 using the back-up URI. Accordingly, even if a streaming error occurs, the streaming module 212 may continuously perform streaming using the pre-obtained back-up URI.

In other words, the streaming module 212 may switch the URI for streaming content provided by the channel from the streaming URI to the back-up URI. Also, the streaming module 212 may receive streaming data from the second server 12 using the switched back-up URI.

Meanwhile, the second server 12 may store streaming schedule data same as the first server 11, but this is only an example. The streaming schedule of the second server 12 may be different from the streaming schedule of the first server 11. In other words, the metadata obtained by the electronic apparatus 100 may be data regarding the streaming schedule of the first server 11.

In this case, the electronic apparatus 100 may further provide a URI for downloading streaming schedule data of the second server 12 along with the back-up URI to the client apparatus 200.

Accordingly, when a streaming error of the first server 11 is identified, the client apparatus 200 may obtain streaming schedule data of the second server 12 using a URI for downloading streaming schedule data of the second server 12. In addition, based on the obtained streaming schedule data of the second server 12, the client apparatus 200 may stream the content that has been streamed from the first server 11, from the second server 12.

Meanwhile, the streaming module 212 may identify whether a streaming error occurs only for the streaming server in which the client apparatus 200 is streaming. In other words, the streaming module 212 may not need to identify a streaming error for each of a plurality of streaming servers. Accordingly, the client apparatus 200 may identify a streaming error by efficiently using a limited computing resource without identifying a streaming error for each of a plurality of streaming servers, and solve the streaming error using a back-up URI.

Meanwhile, the client apparatus 200 may obtain a plurality of back-up URIs from the electronic apparatus 100. In this case, a priority may be set for each of the streaming URI and the plurality of back-up URIs in the order of the streaming URI, the first back-up URI and the second back-up URI. Firstly, when a streaming error of the first server 11 is identified, the streaming module 212 may receive streaming data from the second server 12 using the first back-up URI having a higher priority than the second back-up URI. When a streaming error of the second server 12 is identified, the streaming module 212 may receive streaming data from the third server 13 using the second back-up URI having a lower priority than the first back-up URI.

Meanwhile, when the client apparatus 200 attempts streaming regarding the first channel again after streaming regarding the first channel (i.e., the channel that provides content) using the second server 12 is terminated, the client apparatus 200 may receive streaming data from the first server 11 using the streaming URI again.

For example, when the streaming channel of the client apparatus 200 is changed from the second channel to the first channel, the streaming module 212 may receive streaming data from the first server 11 using the streaming URI.

Alternatively, when the power of the client apparatus 200 is changed from ‘off to’ ‘on’, the client apparatus 200 may receive streaming data from the first server 11 using the streaming URI.

Alternatively, when information including the streaming URI is received from the electronic apparatus 100 while the client apparatus 200 receives streaming data from the second server 12, the streaming module 212 may receive streaming data from the first server 11 using the streaming URI received from the electronic apparatus 100.

In this case, when a streaming error of the first server 11 is identified, the streaming module 212 may receive streaming data from the second server 12 using the back-up URI.

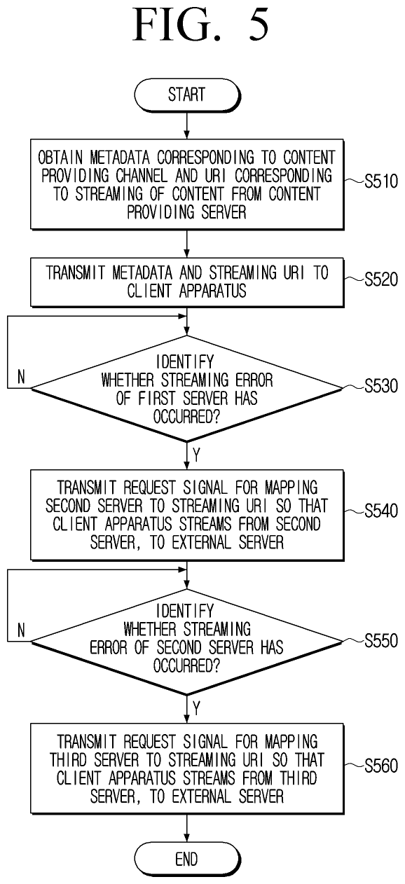

FIG. 5 is a flowchart provided to explain an operation of the electronic apparatus 100 according to one or more embodiments.

The electronic apparatus 100 may obtain metadata corresponding to a content providing channel from the content providing server 10 and a streaming URI corresponding to streaming of the content (S510).

The electronic apparatus 100 may transmit the metadata and the streaming URI to the client apparatus 200 (S520).

When a streaming error of the first server occurs while the client apparatus 200 streams content from the first server 11 using the streaming URI, the electronic apparatus 100 may transmit a signal corresponding to a request for mapping the second server to the streaming URI in order for the client apparatus 200 to stream from the second server, to the external server. Here, the external server may mean a DNS server.

Specifically, while the client apparatus 200 streams content from the first server 11 using the streaming URI, the electronic apparatus 100 may identify whether a streaming error of the first server 11 occurs (S530).

In this case, when a streaming error of the first server 11 is not identified (S530—N), the electronic apparatus 100 may identify whether a streaming error of the first server 11 occurs after a predetermined time (S530). In other words, the electronic apparatus 100 may continuously check whether a streaming error of the first server 11 occurs. When a streaming error of the first server 11 is identified (S530—Y), the electronic apparatus 100 may transmit a signal corresponding to a request for mapping the second server to the streaming URI in order for the client apparatus 200 to stream from the second server 12, to the external server (S540). Specifically, the electronic apparatus 100 may transmit a signal corresponding to the streaming URI matching the URI of the second server and being stored in the database of the external server, to the external server.

In this case, the second server 12 may be a server that provides content same as the content provided by the first server 11. Alternatively, the second server 12 may be a server that provides streaming error occurrence information of the first server 11.

The electronic apparatus 100 may identify whether a streaming error of the second server 12 occurs (S550).

In this case, when a streaming error of the second server 12 is not identified (S550—N), the electronic apparatus 100 may identify whether a streaming error of the second server 12 occurs after a predetermined time (S550). In other words, the electronic apparatus 100 may continuously check whether a streaming error of the second server 12 occurs.

When a streaming error of the second server 12 is identified (S550—Y), the electronic apparatus 100 may transmit a signal corresponding to a request for mapping the third server to the streaming URI in order for the client apparatus 200 to stream from the third server 30, to the external server (S560).

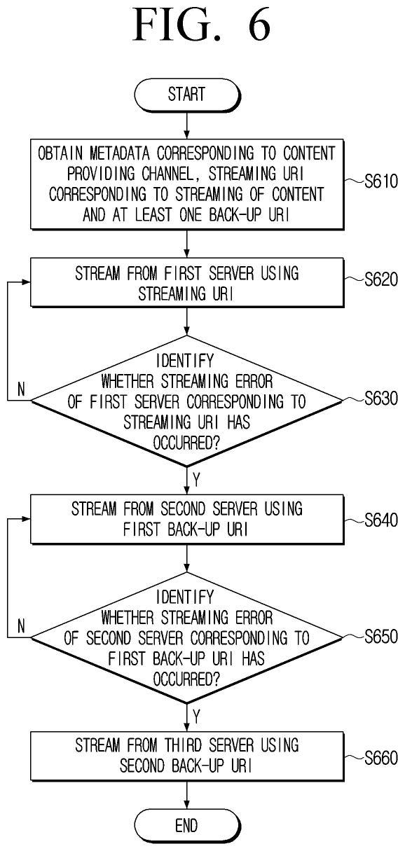

FIG. 6 is a flowchart provided to explain an operation of the client apparatus 200 according to one or more embodiments.

The client apparatus 200 may obtain metadata corresponding to a channel that provides content from the electronic apparatus 100, a streaming URI corresponding to streaming of the content and at least one back-up URI (S610). In this case, the at least one back-up URI may include a first back-up URI and a second back-up URI.

Accordingly, the client apparatus 200 may stream content from the first server 11 corresponding to the streaming URI (S620).

The client apparatus 200 may identify whether a streaming error of the first server 11 corresponding to the streaming URI occurs (S630).

When a streaming error of the first server 11 is not identified (S630—N), the client apparatus 200 may stream content from the first server 11 (S620), and identify whether a streaming error of the first server 11 occurs (S630). When a streaming error of the first server 11 is identified (S630—Y) while streaming content from the first server 11 using the streaming URI, the client apparatus 200 may stream from the second server 12 using the first back-up URI (S640). In this case, the second server 12 may be a server that provides content same as the content provided by the first server 11. Alternatively, the second server 12 may be a server that provides streaming error occurrence information of the first server 11.

The client apparatus 200 may identify whether a streaming error of the second server 12 corresponding to the first back-up URI occurs (S650).

When a streaming error of the second server 12 is not identified (S650—N), the client apparatus 200 may stream content from the second server 12 (S640), and identify whether a streaming error of the second server 12 occurs (S650).

When a streaming error of the second server 12 is identified (S650—Y), the client apparatus 200 may stream from the third server 30 using the second back-up URI (S660).

Meanwhile, terms “˜er/or” or “module” used in the disclosure may include units configured by hardware, software, or firmware, and may be used compatibly with terms such as, for example, logics, logic blocks, components, circuits, or the like. The “unit” or “module” may be an integrally configured component or a minimum unit performing one or more functions or a part thereof. For example, the module may be configured by an application-specific integrated circuit (ASIC).

Various embodiments of the disclosure may be implemented by software including instructions stored in a machine-readable storage medium (for example, a computer-readable storage medium). A machine is a device capable of calling a stored instruction from a storage medium and operating according to the called instruction, and may include the electronic apparatus (for example: electronic apparatus 300) of the disclosed embodiments. In the case in which the above-described command is executed by the processor, the processor may directly perform a function corresponding to the command or other components may perform the function corresponding to the above-described command under a control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

According to one or more embodiments, the methods according to various embodiments disclosed in the present document may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

Each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

What is claimed is:

1. An electronic apparatus comprising:
a memory configured to store at least one instruction; and
at least one processor configured to execute the at least one instruction to:
obtain metadata corresponding to a content providing channel and a streaming Uniform Resource Identifier (URI) corresponding to streaming of content from a content providing server,
transmit the metadata and the streaming URI to a client apparatus, and
based on a streaming error of a first server being occurred while the client apparatus streams the content from the first server using the streaming URI, transmit, to an external server, a signal corresponding to a request for mapping a second server to the streaming URI so that the client apparatus streams from the second server.

2. The electronic apparatus as claimed in claim 1, wherein the signal transmitted to the external server is a signal corresponding to a request for matching and storing a URI of the second server to the streaming URI in a database of the external server.

3. The electronic apparatus as claimed in claim 1, wherein the at least one processor is configured to execute the at least one instruction to, based on a streaming error of the second server being occurred, transmit, to a Domain Name System (DNS) server, a signal corresponding to a request for mapping a third server to the streaming URI so that the client apparatus streams from the third server.

4. The electronic apparatus as claimed in claim 1, wherein the second server is a server that provides content that is same as the content streamed from the first server.

5. The electronic apparatus as claimed in claim 1, wherein the second server is a server providing streaming error occurrence information of the first server.

6. The electronic apparatus as claimed in claim 1, wherein the at least one processor is configured to execute the at least one instruction to:
obtain a plurality of URIs for connecting to a plurality of servers that stream the content; and
set one of the plurality of obtained URIs as a streaming URI.

7. The electronic apparatus as claimed in claim 1, wherein
the memory is configured to store a plurality of first streaming URIs for streaming the content, and
the at least one processor is configured to execute the at least one instruction to:
obtain a plurality of second streaming URIs for streaming the content from the content providing server, and
set one of the plurality of first streaming URIs and the plurality of second streaming URIs as a streaming URI.

8. The electronic apparatus as claimed in claim 1, wherein the at least one processor is configured to execute the at least one instruction to:
receive a first URI for connecting to the first server and a second URI for connecting to the second server,
transmit a streaming URI based on the first URI and a back-up URI based on the second URI to the client apparatus, and
based on a streaming error of the first server being occurred, control the client apparatus to stream from the second server using the back-up URI.

9. A controlling method of an electronic apparatus, the controlling method comprising:
obtaining metadata corresponding to a content providing channel and a streaming Uniform Resource Identifier (URI) corresponding to streaming of content from a content providing server;
transmitting the metadata and the streaming URI to a client apparatus; and
based on a streaming error of a first server being occurred while the client apparatus streams the content from the first server using the streaming URI, transmitting, to an external server, a signal corresponding to a request for mapping a second server to the streaming URI so that the client apparatus streams from the second server.

10. The controlling method as claimed in claim 9, wherein the signal transmitted to the external server is a signal corresponding to a request for matching and storing a URI of the second server to the streaming URI in a database of the external server.

11. The controlling method as claimed in claim 9, wherein the controlling method comprises, based on a streaming error of the second server being occurred, transmitting, to a Domain Name System (DNS) server, a signal corresponding to a request for mapping a third server to the streaming URI so that the client apparatus streams from the third server.

12. The controlling method as claimed in claim 9, wherein the second server is a server providing content that is same as the content streamed from the first server.

13. The controlling method as claimed in claim 9, wherein the second server is a server providing streaming error occurrence information of the first server.

14. The controlling method as claimed in claim 9, wherein the obtaining comprises:
obtaining a plurality of URIs for connecting to a plurality of servers that stream the content; and
setting one of the plurality of obtained URIs as a streaming URI.

15. The controlling method as claimed in claim 9, wherein the obtaining comprises:
obtaining a plurality of second streaming URIs for streaming the content from the content providing server, and
set one of the plurality of first streaming URIs and the plurality of second streaming URIs as a streaming URI.

16. The controlling method as claimed in claim 9, wherein the obtaining comprises:
receiving a first URI for connecting to the first server and a second URI for connecting to the second server,
transmitting a streaming URI based on the first URI and a back-up URI based on the second URI to the client apparatus, and
based on a streaming error of the first server being occurred, control the client apparatus to stream from the second server using the back-up URI.

17. A non-transitory computer-readable recording medium storing a program that, when executed by a processor, causes a controlling method to be performed for controlling an electronic apparatus, the controlling method comprising:
obtaining metadata corresponding to a content providing channel and a streaming Uniform Resource Identifier (URI) corresponding to streaming of content from a content providing server;
transmitting the metadata and the streaming URI to a client apparatus; and
based on a streaming error of a first server being occurred while the client apparatus streams the content from the first server using the streaming URI, transmitting, to an external server, a signal corresponding to a request for mapping a second server to the streaming URI so that the client apparatus streams from the second server.
